(19) United States
(12) Patent Application Publication
(10) Pub. No.: US 2024/0276608 A1
(43) Pub. Date: Aug. 15, 2024

(54) INDUCTION-HEATING APPARATUS

(71) Applicant: SAMSUNG ELECTRONICS CO., LTD., Suwon-si (KR)

(72) Inventors: Taro YOSHIDA, Kanagawa (JP); Nobuharu NISHIKOORI, Kanagawa (JP); Yutaka YAGI, Kanagawa (JP)

(21) Appl. No.: 18/626,329

(22) Filed: Apr. 4, 2024

Related U.S. Application Data
(63) Continuation of application No. PCT/KR2022/017483, filed on Nov. 8, 2022.

(30) Foreign Application Priority Data
Dec. 8, 2021 (JP) 2021-199557
Oct. 14, 2022 (JP) 2022-165333

(51) Int. Cl. H05B 6/06; H05B 1/02; H05B 6/44

(52) U.S. Cl. CPC H05B 6/065; H05B 1/0266; H05B 6/44

(57) ABSTRACT

An induction-heating apparatus includes at least two heating coils configured to heat an object to be heated by induction heating, at least two inverter devices connected to the at least two heating coils, respectively, and configured to supply power to the at least two heating coils, respectively, and a controller configured to control the at least two inverter devices. The controller compares driving frequencies, which are frequencies of the power supplied to the at least two heating coils, with each other, and change a driving frequency of a high-frequency coil having a higher driving frequency to a driving frequency of a low-frequency coil having a lower driving frequency. The controller controls an inverter device corresponding to the low-frequency coil in a first control state, and control an inverter device corresponding to the high-frequency coil in a second control state, which is different from the first control state.

### CROSS-REFERENCE TO RELATED APPLICATION(S)

This application is a continuation application, claiming priority under § 365(c), of International Application No. PCT/KR2022/017483, filed on Nov. 8, 2022, which claims priority to Japanese Patent Application No. 2021-199557, filed on Dec. 8, 2021 and Japanese Patent Application No. 2022-165333, filed on Oct. 14, 2022, and all the benefits accruing therefrom under 35 U.S.C. § 119, the contents of which in their entireties are herein incorporated by reference.

### BACKGROUND

### 1. Field

The disclosure relates to an induction-heating apparatus for induction-heating an object to be heated.

### 2. Description of the Related Art

Induction-heating apparatuses are used in induction heating (IH) type cookers to heat objects to be heated such as, for example, cooking pots. Japanese Patent Application Laid-Open No. 2021-103674 discloses an induction-heating apparatus having a plurality of heating coils to enable simultaneous induction-heating of a plurality of objects to be heated.

In an induction-heating apparatus including a plurality of heating coils, while two heating coils are driven simultaneously, two objects that are heated may have different resonant curves, as shown in FIG. 10. Accordingly, as a result of adjusting the heating power of each of the two heating coils, a difference between the driving frequencies of the two heating coils may reach a certain frequency difference (for example, about 10 kHz), and the frequency difference may cause noise. The occurred noise can be removed by adjusting the heating power to change the frequency difference. However, in this case, it may be difficult to control the individual heating coils to generate desired heating power.

### SUMMARY

In embodiments of an induction-heating apparatus, a heating power of each of a plurality of objects may be adjusted to be heated to a desired level and noise occurring while the plurality of objects are heated simultaneously may be substantially removed or eliminated.

According to an embodiment of the disclosure, an induction-heating apparatus includes at least two heating coils, at least two inverter devices, and a controller. The at least two heating coils are configured to heat an object to be heated by induction heating. In such an embodiment, the at least two inverter devices are connected to the at least two heating coils, respectively. In such an embodiment, the at least two inverter devices supply powers to the corresponding heating coils, respectively. In such an embodiment, the controller is configured to control the at least two inverter devices.

In such an embodiment an embodiment of the disclosure, the controller is configured to compare driving frequencies, which are frequencies of the powers supplied to the at least two heating coils, with each other. In such an embodiment, a heating coil having a higher driving frequency among the at least two heating coils is the high-frequency coil and a heating coil having a lower driving frequency is the low-frequency coil. In such an embodiment, the controller is configured to change the driving frequency of the high-frequency coil to the driving frequency of the low-frequency coil. In such an embodiment, the controller is configured to control the inverter device corresponding to the low-frequency coil in a first control state. In such an embodiment, the controller is configured to control the inverter device corresponding to the high-frequency coil in a second control state, which is different from the first control state.

According to an embodiment of the disclosure, while a power of a preset driving frequency is supplied to one heating coil among the at least two heating coils, a power starts being supplied to another heating coil among the at least two heating coils. In such an embodiment, the controller is configured to supply a power of an initial frequency that is higher than the preset driving frequency to all the at least two heating coils. Then, the controller is configured to control the at least two inverter devices to lower frequencies of the power supplied to all the at least two heating coils, until an output of the one heating coil matches with a target output thereof.

### BRIEF DESCRIPTION OF THE DRAWINGS

FIG. 1 is a schematic configuration view of an induction-heating apparatus according to an embodiment of the disclosure.

FIG. 2 is a flowchart showing an embodiment of a control operation of an induction-heating apparatus by a controller.

FIG. 3 is a view showing an embodiment of a first control state.

FIG. 4 illustrates graphs showing an embodiment of driving frequency adjustable ranges of heating coils.

FIG. 5 is a view showing an embodiment of a second control state.

FIG. 6 is a view showing an embodiment of a third control state.

FIG. 7 illustrates graphs showing an embodiment of sequential changes of control states.

FIG. 8 illustrates graphs showing an embodiment of sequential changes of on duty ratios and frequencies according to control operations.

FIG. 9 is a flowchart showing an embodiment of a control operation of an induction-heating apparatus by a controller.

FIG. 10 is a view showing a relationship between resonant curves and noise.

FIG. 11 is a graph showing an embodiment of a relationship between driving frequencies of heating coils and frequencies at peaks of resonant curves.

FIG. 12 is a flowchart showing an embodiment of an operation of controlling an induction-heating apparatus by a controller.

FIG. 13 illustrates graphs showing sequential changes of driving frequencies in a control operation according to an embodiment of the disclosure, shown in FIG. 12.

FIG. 14 illustrates graphs showing sequential changes of outputs (powers) in a control method according to an embodiment of the disclosure, shown in FIG. 12.

FIG. 15 is a graph showing occurrence of frequency noise in a process of matching driving frequencies of powers supplied to two heating coils.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Although general terms currently widely used were selected as terminology used in the present specification while considering the functions of the disclosure, they may vary according to intentions of one of ordinary skill in the art, judicial precedents, the advent of new technologies, and the like.

Terms arbitrarily selected by the applicant of the disclosure may also be used in a specific case, and in this case, their meanings will be given in detail in the detailed description of the disclosure.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hence, the terms used in the disclosure must be defined based on the meanings of the terms and the contents of the entire specification, not by simply stating the terms themselves. In the entire specification, it will be understood that when a certain part “includes” a certain component, the part does not exclude another component but can further include another component, unless the context clearly dictates otherwise.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of an induction-heating apparatus according to the disclosure will be described in detail to be easily embodied by one of ordinary skill in the technical field to which the disclosure belongs. However, the disclosure may be implemented in various different forms, and is not limited to the embodiments which will be described below.

Also, in the drawings, parts that are irrelevant to the descriptions may be not shown in order to clearly describe the disclosure, and throughout the specification, similar portions are assigned similar reference numerals. The disclosure relates to an induction-heating apparatus capable of adjusting a heating power of each of a plurality of heating coils to a desired level and eliminating noise occurring while the plurality of heating coils are driven simultaneously.

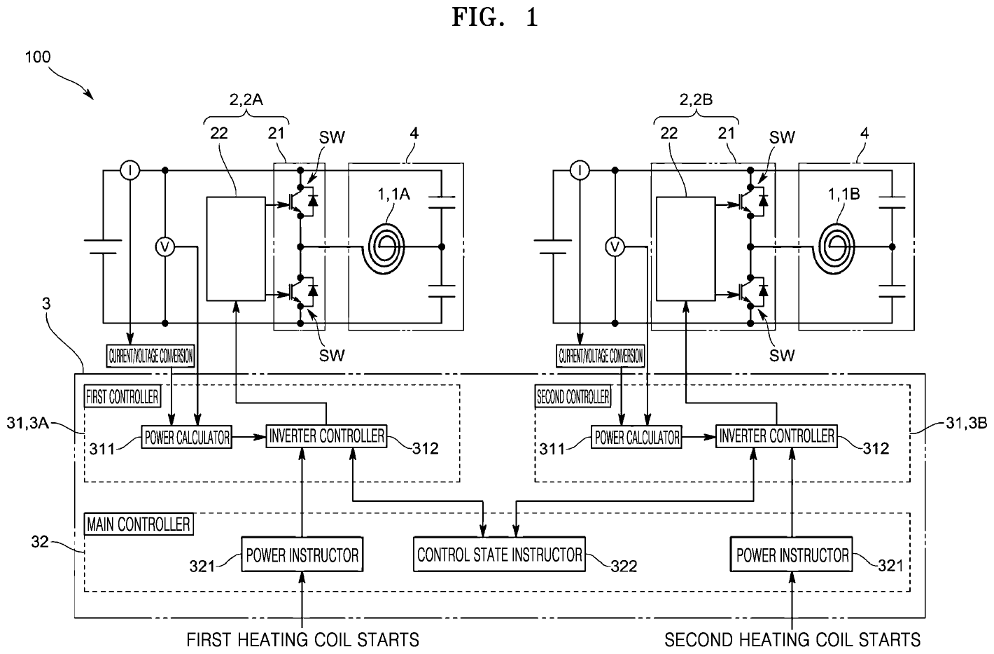

FIG. 1 is a schematic configuration view of an induction-heating apparatus 100 according to an embodiment of the disclosure.

The induction-heating apparatus 100 according to an embodiment may be used in, for example, an induction heating (IH) type cooker, etc. and heat an object to be heated, such as a cooking pot, by induction-heating. Referring to FIG. 1, the induction-heating apparatus 100 may include a plurality of heating coils 1 for induction-heating an object to be heated, a plurality of inverter devices 2 for supplying powers to the plurality of heating coils 1, and a controller 3 for controlling the plurality of inverter devices 2. The induction-heating apparatus 100 may include an LC parallel resonance circuit 4 including a resonant capacitor connected in series to each heating coil 1 and a resonant coil element connected in parallel to the resonant capacitor, a current detector I for detecting current supplied to each inverter device 2, and a voltage detector V for detecting a voltage supplied from a commercial power supply to the inverter device 2.

The heating coil 1 may be installed below a top plate (not shown) on which a cooking pot, etc. is to be placed, and induction-heat the cooking pot with the top plate in between. The induction-heating apparatus 100 according to an embodiment of the disclosure, as shown in FIG. 1, may include two heating coils 1, that is, a first heating coil 1A and a second heating coil 1B. However, a number of the heating coils 1 is not limited to this, and the number of the heating coils 1 may be at least two.

Accordingly, in an embodiment, the number of the heating coils 1 may be three or more. The inverter device 2 may include an inverter circuit 21 for supplying high-frequency current to the heating coil 1, and a driving circuit 22 for driving the inverter circuit 21. The inverter circuit 21 may convert a power supplied from the commercial power supply to a high-frequency power, and supply the high-frequency power to the heating coil 1.

In an embodiment, for example, a half bridge type inverter circuit 21 using a switching device SW may be applied. The inverter circuit 21 may be implemented by various electrical circuits capable of supplying a high-frequency power to the heating coil 1. For example, the inverter circuit 21 may be implemented as a full bridge type. The driving circuit 22 may operate the switching device SW of the inverter circuit 21. The driving circuit 22 may turn on/off the switching device SW based on a control signal from the controller 3 which will be described below. A number of the inverter devices 2 may be the same as the number of the heating coils 1. For example, at least two inverter devices 2 may be provided. In an embodiment, the inverter devices 2 may include first and second inverter devices 2A and 2B respectively corresponding to the first and second heating coils 1A and 1B. The controller 3 may control each inverter device 2 to heat an object to be heated with a desired heating power. The controller 3 may control a driving frequency that is a frequency of a high-frequency power supplied from the inverter device 2 to the heating coil 1.

In an embodiment, the controller 3 may include a plurality of individual controllers 31 for respectively controlling the plurality of inverter devices 2, and a main controller 32 for collectively controlling the plurality of individual controllers 31. The controller 3 may include at least one processor and a memory. The processor may include a central process unit (CPU).

In an embodiment, one, two, or more processors may be provided. For example, each of the plurality of individual controllers 31 and the main controller 32 may include a processor. The memory may store an application program for controlling the induction-heating apparatus 100 and/or an electronic device (for example, a cooker) adopting the induction-heating apparatus 100. The memory may store various control factors, such as driving frequency, etc., used to control the induction-heating apparatus 100 and/or the electronic device adopting the induction-heating apparatus 100. The processor may execute the application program to control components of the induction-heating apparatus 100 and/or the electronic device adopting the induction-heating apparatus 100. The plurality of individual controllers 31, the main controller 32, and lower units thereof, for example, a power calculator 311, an inverter controller 312, a power instructor 321, a control state instructor 322, etc., which will be described below, may be functional blocks that are implemented by the application program executed on the processor, or combined types of functional blocks and hardware suitable to implement functions of the functional blocks. Each of the individual controllers 31 may include the power calculator 311 that calculates an actual power (actual output) supplied to the heating coil 1, based on detection current and a detection voltage detected by the current detector I and the voltage detector V, and the inverter controller 312 that controls the inverter device 2 such that the actual power reaches a target power (target output). The main controller 32 may include an operation controller that is controlled by a user.

The main controller 32 may include the power instructor 321 that outputs, as a target power, a power corresponding to a heating power of the heating coil 1 set by the user, to the inverter controller 312, and the control state instructor 322 that converts a control state by the inverter controller 312. Hereinafter, an individual controller 31 for controlling the first inverter device 2A is referred to as a first controller 3A and an individual controller 31 for controlling the second inverter device 2B is referred to as a second controller 3B.

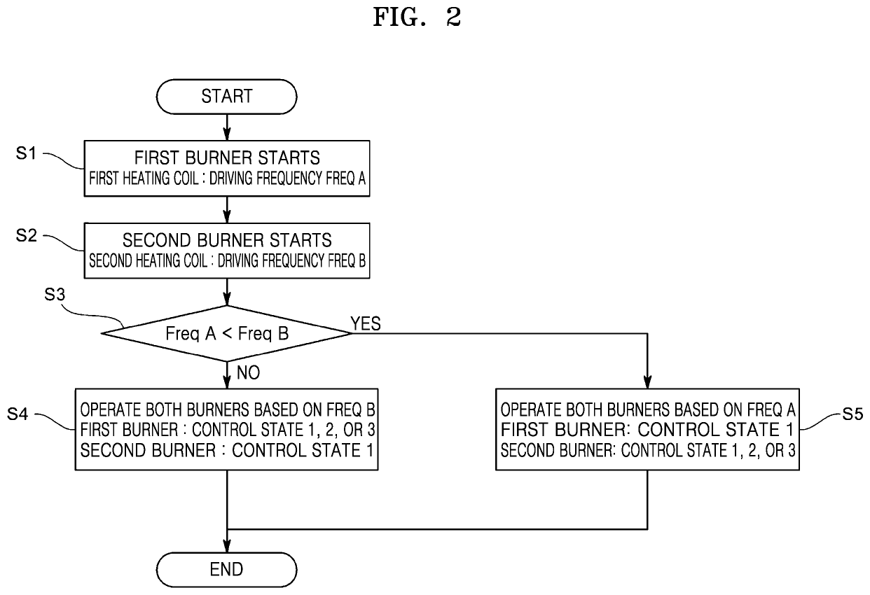

FIG. 2 is a flowchart showing an embodiment of a control operation of the induction-heating apparatus 100 by the controller 3. Referring to FIG. 2, an embodiment of a control operation by the controller 3 will be described.

Herein, a case in which a first burner corresponding to the first heating coil 1A starts first, and then, a second burner corresponding to the second heating coil 1B starts will be described as an example. First, the power instructor 321 of the main controller 32 may indicate, to the first controller 3A and the second controller 3B, target powers (for example, wattage) as target outputs corresponding to heating powers of the respective burners. The first controller 3A may adjust a driving frequency of a power that is supplied from the first inverter device 2A to the first heating coil 1A, based on the instruction from the main controller 32 (S1).

The second controller 3B may adjust a driving frequency of a power that is supplied from the second inverter device 2B to the second heating coil 1B, based on the instruction from the main controller 32 (S2). More specifically, the first controller 3A may control a driving frequency of the first inverter device 2A through the inverter controller 312 such that an actual power calculated in the power calculator 311 is equal to the target power. The second controller 3B may control a driving frequency of the second inverter device 2B through the inverter controller 312 such that an actual power calculated in the power calculator 311 is equal to the target power.

At this time, the first controller 3A and the second controller 3B may control the first inverter device 2A and the second inverter device 2B, respectively, in a preset first control state, and a driving frequency Freq A of the first heating coil 1A and a driving frequency Freq B of the second heating coil 1B may be different from each other.

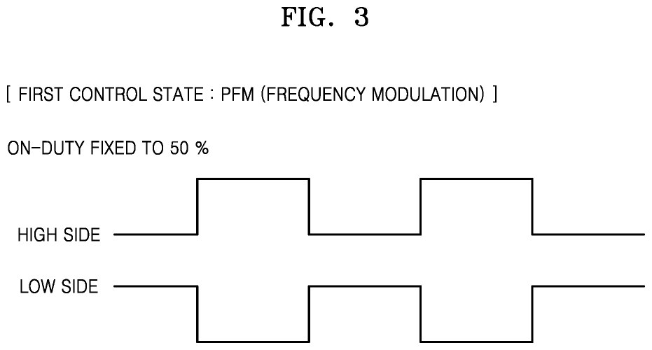

FIG. 3 is a view showing an embodiment of the first control state. Referring to FIG. 3, the first control state may be a control state of turning on/off the switching device SW in the inverter device 2 with a fixed duty ratio.

For example, the first control state shown in FIG. 3 may be implemented by a pulse-frequency modulation (PFM) control in which an on duty ratio is fixed to 50%. In the first control state, the fixed duty ratio is not limited to 50%. In the first control state, various fixed duty ratios, in which a duty ratio of a switching device SW of a high side and a duty ratio of a switching device SW of a low side maintain an interpolation relationship, may be applied. For example, a duty ratio of the switching device SW of the high side may be set to 60%, and a duty ratio of the switching device SW of the low side may be set to 40%. The first control state is not limited to the PFM control. For example, the first control state may be implemented by a pulse-width modulation (PWM) control. Then, the control state instructor 322 of the main controller 32 may obtain the driving frequency Freq A of the first heating coil 1A and the driving frequency Freq B of the second heating coil 1B and compare the driving frequency Freq A with the driving frequency Freq B (S3). Hereinafter, one heating coil having a higher driving frequency between the first heating coil 1A and the second heating coil 1B is referred to as a high-frequency coil, and another heating coil having a lower driving frequency between the first heating coil 1A and the second heating coil 1B is referred to as a low-frequency coil.

The control state instructor 322 may instruct the inverter controller 312 for controlling the high-frequency coil to change the driving frequency of the high-frequency coil to the driving frequency of the low-frequency coil (S4 and S5). As a result, the driving frequency of the first heating coil 1A may become equal to the driving frequency of the second heating coil 1B (hereinafter, the driving frequency is referred to as a first driving frequency). In an embodiment, for example, the driving frequency Freq B of the second heating coil 1B may be higher than the driving frequency Freq A of the first heating coil 1A. In this case, the control state instructor 322 may instruct the inverter controller 312 of the second controller 3B to change the driving frequency of the second heating coil 1B which is a high-frequency coil to the driving frequency Freq A of the first heating coil 1A which is a low-frequency coil. Accordingly, both the first heating coil 1A and the second heating coil 1B may operate based on a same driving frequency Freq A.

In an embodiment, the driving frequency Freq B of the second heating coil 1B may be lower than the driving frequency Freq A of the first heating coil 1A. In this case, the control state instructor 322 may instruct the inverter controller 312 of the first controller 3A to change the driving frequency of the first heating coil 1A which is a high-frequency coil to the driving frequency Freq B of the second heating coil 1B which is a low-frequency coil. Accordingly, both the first heating coil 1A and the second heating coil 1B may operate based on a same driving frequency Freq B.

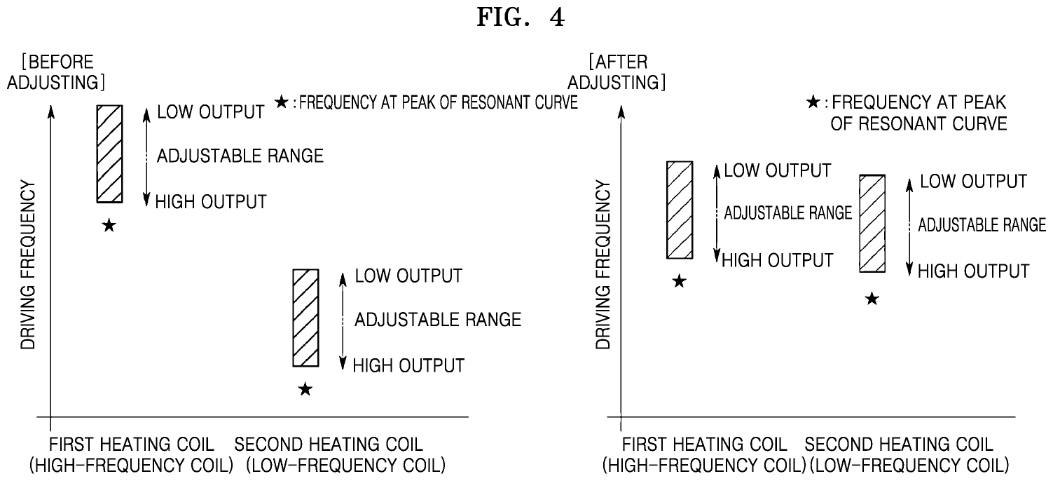

FIG. 4 illustrates graphs showing an embodiment of driving frequency adjustable ranges of heating coils. Driving frequency adjustable ranges of the first heating coil 1A and the second heating coil 1B may be dispersed as shown in a graph at a left side of FIG. 4. In this case, when a driving frequency of a high-frequency coil (for example, the first heating coil 1A) is adjusted to a driving frequency of a low-frequency coil (for example, the second heating coil 1B), the driving frequency of the high-frequency coil may become lower than a frequency (a frequency marked with an asterisk in FIG. 4) at a peak of a resonant curve.

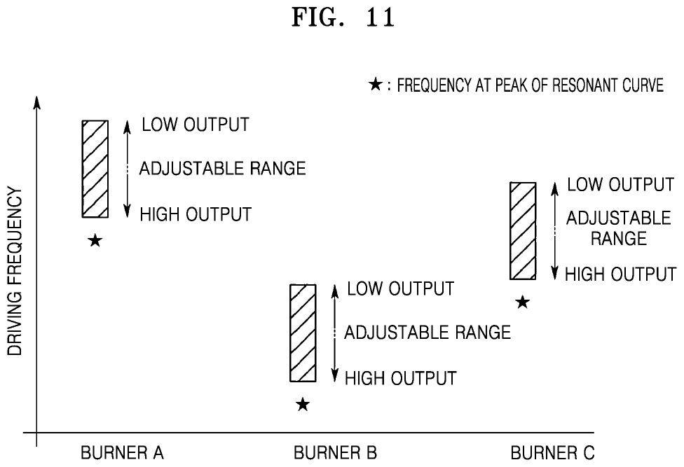

In this case, the switching device SW may be damaged by hard switching. This problem may also occur in an induction-heating apparatus having three heating coils as shown in FIG. 11. In the induction-heating apparatus 100 according to an embodiment, a driving frequency adjustable range of the first heating coil 1A may be higher than a frequency at a peak of a resonance curve of an object that is heated by the second heating coil 1B, as shown in a graph at a right side of FIG. 4. Also, a driving frequency adjustable range of the second heating coil 1B may be higher than a frequency at a peak of a resonant curve of an object that is heated by the first heating coil 1A.

These conditions may be implemented by adjusting numbers of turns of the first and second heating coils 1A and 1B and/or capacitance of a resonant capacitor. That is, numbers of turns of the first and second heating coils 1A and 1B and/or capacitance of the resonant capacitor that satisfy the above-described conditions may be set. In this way, by matching the driving frequency of the first heating coil 1A with the driving frequency of the second heating coil 1B, the driving frequency of the high-frequency coil may be lowered to the first driving frequency from an initial driving frequency (the frequency Freq A in operation S1 or the frequency Freq B in operation S2). The heating coil 1 may be driven at a higher driving frequency than a frequency at a peak of a resonant curve.

As the driving frequency of the heating coil 1 becomes closer to the frequency at the peak of the resonant curve, a heating power of the heating coil 1 may increase. While the driving frequency of the high-frequency coil changes to the driving frequency of the low-frequency coil to be lowered to the first driving frequency, the driving frequency of the high-frequency coil may become close to the frequency at the peak of the resonant curve, and accordingly, a heating power of the high-frequency coil may become greater than a desired heating power. Accordingly, a control for lowering the heating power of the high-frequency coil may be desired. However, because the driving frequency of the low-frequency coil does not change, a heating power of the low-frequency coil may not change. The controller 3 may maintain a control of the inverter device 2 corresponding to the low-frequency coil in the first control state, and convert a control of the inverter device 2 corresponding to the high-frequency coil into the second control state that is different from the first control state (S4 and S5). For example, according to a driving frequency Freq B of the second heating coil 1B being higher than a driving frequency Freq A of the first heating coil 1A, the controller 3 may change the driving frequency of the second heating coil 1B being a high-frequency coil to the driving frequency Freq A of the first heating coil 1A being a low-frequency coil.

Then, the controller 3 may maintain a control state of the first inverter device 2A corresponding to the first coil 1A being the low-frequency coil in the first control state, and convert a control state of the second inverter device 2B corresponding to the second coil 1B being the high-frequency coil into the second control state that is different from the first control state. However, according to a driving frequency Freq B of the second heating coil 1B being higher than a driving frequency Freq A of the first heating coil 1A, the controller 3 may change the driving frequency of the first heating coil 1A being a high-frequency coil to the driving frequency Freq B of the second heating coil 1B being a low-frequency coil. Then, the controller 3 may maintain a control state of the second inverter device 2B corresponding to the second coil 1B being the low-frequency coil in the first control state, and convert a control state of the first inverter device 2A corresponding to the first coil 1A being the high-frequency coil into the second control state that is different from the first control state.

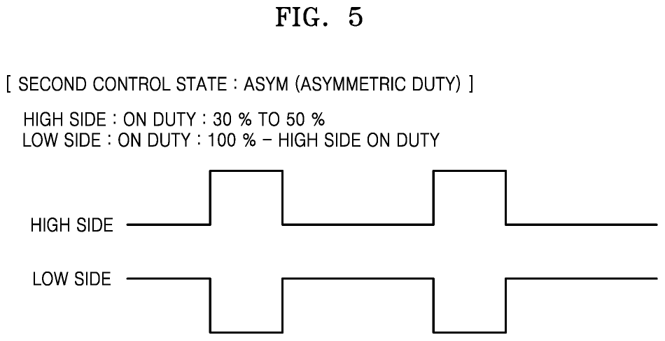

FIG. 5 is a view showing an embodiment of the second control state. Referring to FIG. 5, the second control state may be a control state of turning on/off the switching device SW of the inverter device 2 with a variable duty ratio.

The second control state may be an asymmetric control state of causing an on-duty ratio of a switching device SW of a high side to be different from an on-duty ratio of a switching device SW of a low side. For example, in the second control state, the inverter controller 312 may compare an actual power supplied to a high-frequency coil with a target power corresponding to a target heating power, and lower an on-duty ratio of a switching device SW of the high side such that the actual power matches with the target power, that is, an output of the high-frequency coil matches with a target output. According to an embodiment, the on-duty ratio of the switching device SW of the high side may change in a range of 30% to 50%. An on-duty ratio of a switching device SW of a low side may become a value resulting from subtracting the on-duty ratio of the switching device SW of the high side from 100%.

As a result of the on-duty ratio of the switching device SW of the high side being lower than, for example, 30%, the switching device SW may fail. However, a lower limit of an on duty ratio, which may cause failure of the switching device SW, is not limited to 30% and may vary depending on a configuration of the induction-heating apparatus 100.

As such, by lowering an on-duty ratio of a switching device SW of a high side to match an actual power of a high-frequency coil with the target power, an output of the high-frequency coil may match with the target output. Accordingly, heating powers of the burners respectively corresponding to the first heating coil 1A and the second heating coil 1B may be adjusted to desired levels.

In an embodiment, even though the on-duty ratio of the switching device SW of the high side is lowered to the lower limit (30%) of the changeable range, an actual power of the high-frequency coil may not reach the target power, that is, an output of the high-frequency coil may not reach the target output. In this case, a heating power of a burner corresponding to the high-frequency coil may not be adjusted to a desired level. In this case, the control state instructor 322 may instruct the inverter controller 312 of the individual controller 31 corresponding to the high-frequency coil to convert a control of the inverter device 2 corresponding to the high-frequency coil into a third control state from the second control state.

The third control state may be a control state that is different from the second control state. For example, according to a driving frequency Freq B of the second heating coil 1B being higher than a driving frequency Freq A of the first heating coil 1A, the controller 3 may change the driving frequency of the second heating coil 1B being a high-frequency coil to the driving frequency Freq A of the first heating coil 1A being a low-frequency coil. Then, the controller 3 may maintain a control state of the first inverter device 2A corresponding to the first coil 1A being the low-frequency coil in the first control state, and convert a control state of the second inverter device 2B corresponding to the second coil 1B being the high-frequency coil into the second control state that is different from the first control state.

According to an actual power of the second heating coil 1B being the high-frequency coil, which does not reach the target power by a control according to the second control state, the control state instructor 322 of the main controller 32 may instruct the inverter controller 312 of the second controller 3B to convert a control of the second inverter device 2B corresponding to the second heating coil 1B into the third control state from the second control state. However, according to a driving frequency Freq B of the second heating coil 1B being higher than a driving frequency Freq A of the first heating coil 1A, the controller 3 may change the driving frequency of the first heating coil 1A being a high-frequency coil to the frequency Freq B of the second heating coil 1B being a low-frequency coil. Then, the controller 3 may maintain a control state of the second inverter device 2B corresponding to the second coil 1B being the low-frequency coil in the first control state, and convert a control state of the first inverter device 2A corresponding to the first coil 1A being the high-frequency coil into the second control state that is different from the first control state.

According to an actual power of the first heating coil 1A being the high-frequency coil, which does not reach the target power by a control according to the second control state, the control state instructor 322 of the main controller 32 may instruct the inverter controller 312 of the first controller 3A to convert a control of the first inverter device 2A corresponding to the first heating coil 1A into the third control state from the second control state.

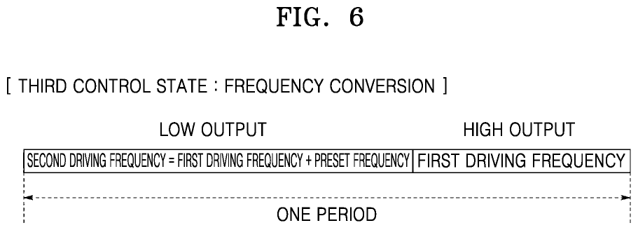

FIG. 6 is a view showing an embodiment of the third control state. Referring to FIG. 6, the third control state according to an embodiment may be a control state of converting a driving frequency of a high-frequency coil into the above-described first driving frequency and a second driving frequency resulting from summing the first driving frequency and a preset frequency at preset periods.

That is, the third control state may be a state in which a driving frequency of a high-frequency coil is time-divisionally controlled into a first driving frequency that is a driving frequency of a low-frequency side coil and a second driving frequency that is higher than the first driving frequency. In the third control state, because a driving frequency of a low-frequency coil maintains the first driving frequency while a driving frequency of a high-frequency coil changes from the first driving frequency to the second driving frequency, the driving frequency of the high-frequency coil may become different from the driving frequency of the low-frequency coil.

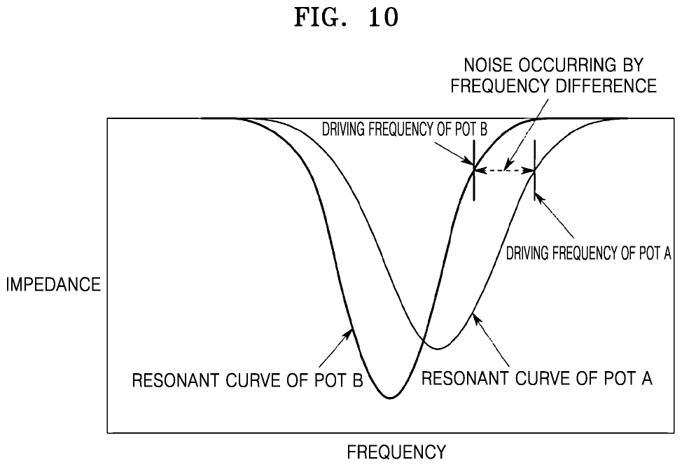

FIG. 10 is a view showing a relationship between resonant curves and noise. Referring to FIG. 10, because resonant curves of two objects to be heated, for example, a pot A and another pot B are different from each other, a certain difference between driving frequencies of two heating coils 1A and 1B that induction-heat the pot A and the other pot B may cause noise.

For example, a difference of, for example, about 10 kHz between a driving frequency of a high-frequency coil and a driving frequency of a low-frequency coil may cause noise. Accordingly, in an embodiment, a difference between a driving frequency of a high-frequency coil and a driving frequency of a low-frequency coil may be set to 15 kHz or greater. In the third control state according to an embodiment, the inverter controller 312 may change a ratio of a driving time of the first driving frequency and a driving time of the second driving frequency, included in a time period. For example, to match an actual power of a high-frequency coil with a target power, that is, to match an output of the high-frequency coil with a target output, the inverter controller 312 may increase the driving time of the second driving frequency.

In an embodiment, as described above, by increasing the driving time of the second driving frequency to match the actual power of the high-frequency coil with the target power, the output of the high-frequency coil may match with the target output. Accordingly, heating powers of burners respectively corresponding to the first heating coil 1A and the second heating coil 1B may be adjusted to desired levels. In the third control state, as a result of attempting to approximate an actual output of the high-frequency coil to the target output, the driving time of the second driving frequency may become very long. In this case, a difference between a driving frequency of the low-frequency coil and a driving frequency of the high-frequency coil may become great. Accordingly, although the first and second heating coils 1A and 1B are driven at different driving frequencies, a level of occurred noise may be a level that is difficult to be recognized or perceived as noise.

Accordingly, when a ratio of a driving time of the second driving frequency with respect to a driving time of the first driving frequency exceeds a threshold value, the control state instructor 322 may instruct the inverter controllers 312 of the first and second controllers 3A and 3B to convert control states by the first and second inverter devices 2A and 2B into a control state of driving the first heating coil 1A and the second heating coil 1B at different driving frequencies from the third control state. At this time, the converted control state may be the first control state described above. Accordingly, the switching device SW of the first inverter device 2A and the switching device SW of the second inverter device 2B may be PFM-controlled at the same fixed duty ratio.

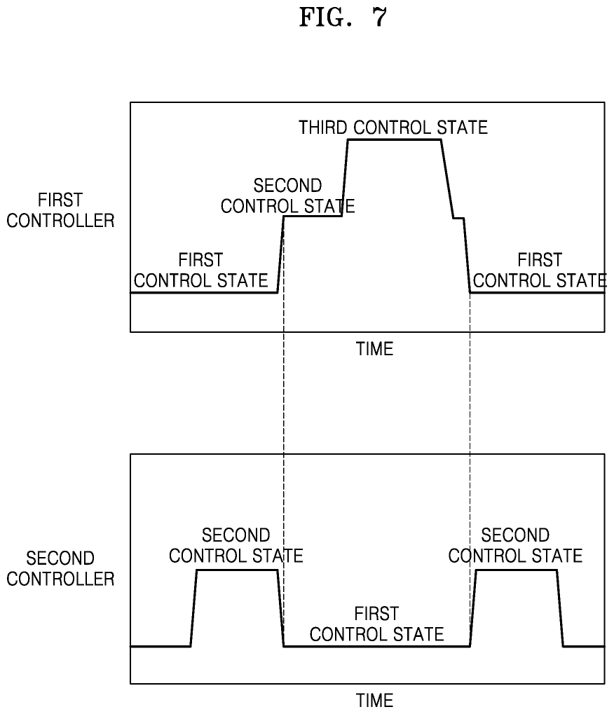

FIG. 7 illustrates graphs showing an embodiment of sequential changes of control states. By the above-described control operation, as shown in FIG. 7, a driving frequency of one of the first heating coil 1A or the second heating coil 1B may be controlled by the first control state, and simultaneously, a driving frequency of another of the first heating coil 1A or the second heating coil 1B may be controlled by the first to third control states.

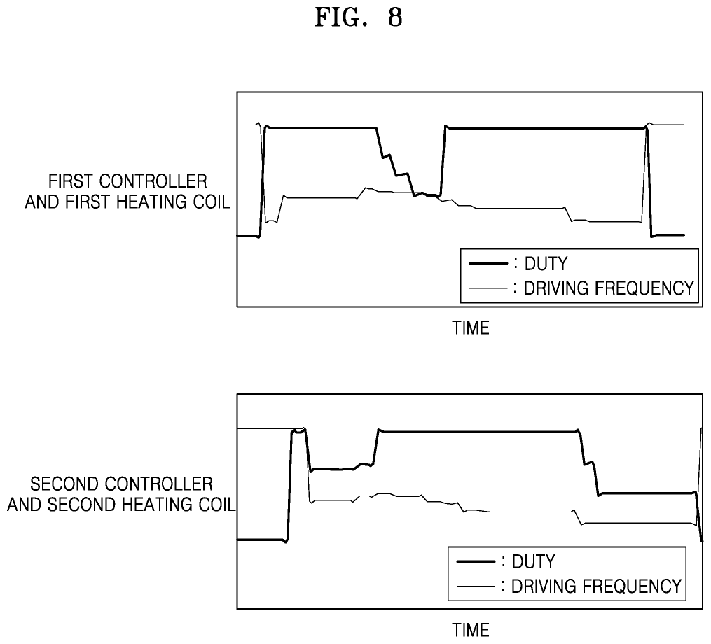

FIG. 8 illustrates graphs showing an embodiment of sequential changes of on duty ratios and frequencies according to control operations. As a result of changes of control states according to the above-described control operations, as shown in FIG. 8, while on-duty ratios of the switching devices SW change, a driving frequency of the first heating coil 1A may be synchronized with a driving frequency of the second heating coil 1B, and simultaneously, heating powers of the burners respectively corresponding to the first heating coil 1A and the second heating coil 1B may be adjusted to desired levels. By the induction-heating apparatus 100 configured as described above, because a driving frequency of a high-frequency coil is adjusted to a driving frequency of a low-frequency coil, occurrence of noise due to a frequency difference may be substantially reduced or effectively prevented. In addition, because a control state of the inverter device 2 corresponding to a high-frequency coil is converted into the second control state or the third control state that is different from the first control state of the inverter device 2 corresponding to a low-frequency coil, heating powers of the first and second heating coils 1A and 1B may be adjusted to desired levels.

A control operation of the induction-heating apparatus 100 by the controller 3 is not limited to those described above.

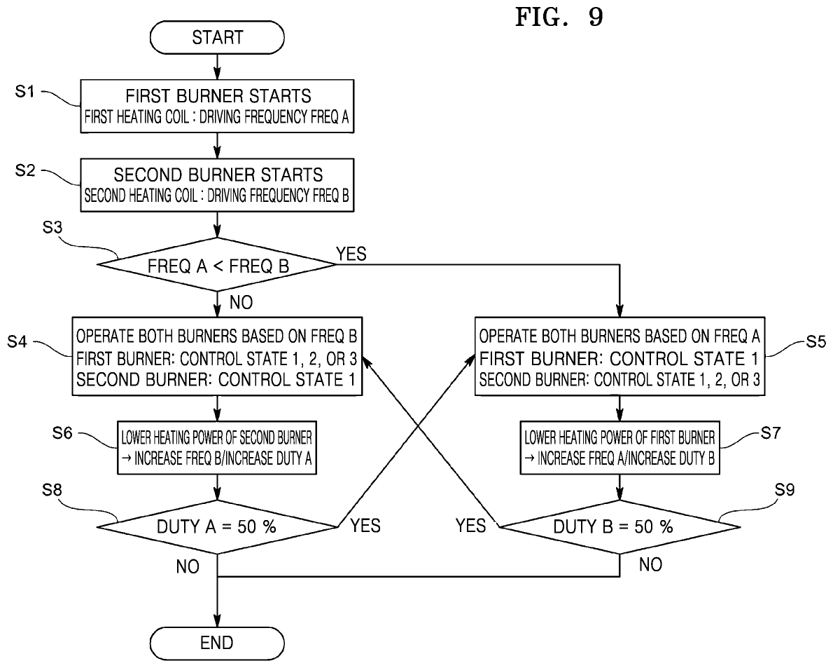

FIG. 9 is a flowchart showing an embodiment of a control operation of the induction-heating apparatus 100 by the controller 3.

For example, there may be a case in which a magnitude relationship of driving frequencies of the plurality of heating coils 1 are reversed by a change in heating power of a plurality of burners. In this case, to adjust a heating power of each of the heating coils 1 to a desired level while eliminating noise, the controller 3 may perform a control operation as shown in the flowchart of FIG. 9. According to a change of a driving frequency of the other heating coil 1 not being a low-frequency coil to a driving frequency lower than a driving frequency of a low-frequency coil, the controller 3 may change the driving frequency of the low-frequency coil to the driving frequency of the other heating coil 1, convert a control state of the inverter device 2 corresponding to the low frequency coil into the second control state, and convert a control state of the inverter device corresponding to the other heating coil 1 into the first control state. The other heating coil 1 may be a high-frequency coil or another heating coil 1 that is different from a high-frequency coil.

The control operation of the controller 3 will be described in more detail. As shown in FIG. 9, operations S1 to S5 of matching a driving frequency of a high-frequency coil with a driving frequency of a low-frequency coil have been described above with reference to FIGS. 2 to 8. Hereinafter, a case in which the inverter device 2 corresponding to the high-frequency coil is controlled in the second control state in operations S4 and S5 will be described as an example.

The low-frequency coil may be controlled in the first control state. In this state, as a result of lowering a heating power of a burner of the low-frequency coil, the driving frequency of the low-frequency coil may increase, and an on-duty ratio of a switching device SW corresponding to the high-frequency coil may increase correspondingly (S6 and S7). For example, in operation S4, the second heating coil 1B being a low-frequency coil may be controlled in the first control state, and the first heating coil 1A being a high-frequency coil may be controlled in the second control state. The driving frequency of the first and second heating coils 1A and 1B may be Freq B.

In this case, when lowering a heating power of the second heating coil 1B being the low-frequency coil, the driving frequency of the second heating coil 1B may increase. The reason may be because a driving frequency of each heating coil 1 is higher than a frequency at a peak of a resonant curve, and the farther the driving frequency is from the frequency at the peak of the resonant curve, the lower a heating power of the heating coil 1 is. Also, when lowering a heating power of the second heating coil 1B being the low-frequency coil, an on-duty ratio of the switching device SW of the first inverter device 2A corresponding to the first heating coil 1A being the high-frequency coil may increase. For example, in operation S5, the first heating coil 1A being the low-frequency coil may be controlled in the first control state, and the second heating coil 1B being the high-frequency coil may be controlled in the second control state. The driving frequency of the first and second heating coils 1A and 1B may be Freq A.

In this case, when lowering a heating power of the first heating coil 1A being the low-frequency coil, the driving frequency of the first heating coil 1A may increase, and an on-duty ratio of the switching device SW of the second inverter device 2B corresponding to the second heating coil 1B being the high-frequency coil may increase. According to the driving frequency of the low-frequency coil reaching the driving frequency of the high-frequency coil, an on-duty ratio of the driving frequency of the high-frequency coil may reach 50%. The controller 3 may identify, as shown in FIG. 9, whether the on-duty ratio of the switching device SW corresponding to the high-frequency coil has reached 50% (S8 and S9).

According to the on-duty ratio of the switching device SW corresponding to the high-frequency coil, which has reached 50%, the controller 3 may reverse definitions of the high-frequency coil and the low-frequency coil. That is, according to the on-duty ratio of the switching device SW corresponding to the high-frequency coil, which has reached 50%, the controller 3 may convert a control of the heating coil 1 that has been controlled as a high-frequency coil into a control of a low-frequency coil, and simultaneously convert a control of the heating coil 1 that has been controlled as a low-frequency coil into a control of a high-frequency coil (S4 and S5). For example, in operation S4, the second heating coil 1B being a low-frequency coil may be controlled in the first control state, and the first heating coil 1A being a high-frequency coil may be controlled in the second control state. The driving frequency of the first and second heating coils 1A and 1B may be Freq B.

In this case, in operation S6, as a result of lowering a heating power of the second heating coil 1B being the low-frequency coil, the driving frequency of the second heating coil 1B may increase because a driving frequency of each heating coil 1 is higher than a frequency at a peak of a resonant curve, and the farther the driving frequency is from the frequency at the peak of the resonant curve, the lower a heating power of the heating coil 1 is. Also, when lowering a heating power of the second heating coil 1B being the low-frequency coil, an on-duty ratio DUTY A of the switching device SW of the first inverter device 2A corresponding to the first heating coil 1A being the high-frequency coil may increase. According to the on-duty ratio DUTY A of the switching device SW of the first inverter device 2A, which has reached 50%, the controller 3 may set the second heating coil 1B to be a high-frequency coil and set the first heating coil 1A to be a low-frequency coil, and perform a corresponding control operation. For example, in operation S5, the first heating coil 1A being a low-frequency coil may be controlled in the first control state, and the second heating coil 1B being a high-frequency coil may be controlled in the second control state. The driving frequency of the first and second heating coils 1A and 1B may be Freq A.

In this case, when lowering a heating power of the first heating coil 1A being a low-frequency coil, the driving frequency of the first heating coil 1A may increase, and an on-duty ration DUTY B of the switching device SW of the second inverter device 2B corresponding to the second heating coil 1B being a high-frequency coil may increase. According to the on-duty ratio DUTY B of the switching device SW of the second inverter device 2B, which has reached 50%, the controller 3 may change the first heating coil 1A to a high-frequency coil and the second heating coil 1B to a low-frequency coil, and perform a corresponding control operation. By this configuration, even though a magnitude relationship of driving frequencies that realize target heating powers in the plurality of heating coils 1 is reversed, heating powers of the individual burners may be adjusted to desired levels while eliminating noise. The disclosure may provide an induction-heating apparatus capable of adjusting heating powers of a plurality of objects to be heated to desired levels and eliminating noise that may occur while the objects are heated simultaneously.

The induction-heating apparatus according to an embodiment of the disclosure may include: at least two heating coils configured to heat an object to be heated by induction-heating; at least two inverter devices connected to respectively to the at least two heating coils and configured to supply powers to the corresponding heating coils; and a controller configured to control the at least two inverter devices.

The controller may compare driving frequencies that are frequencies of powers supplied to the at least two heating coils, change the driving frequency of a high-frequency coil to the driving frequency of a low-frequency coil, control the inverter device corresponding to the low-frequency coil in a first control state, and control the inverter device corresponding to the high-frequency coil in a second control state that is different from the first control state, where a heating coil having a higher driving frequency between the at least two heating coils is the high-frequency coil and a heating coil having a lower driving frequency between the at least two heating coils is the low-frequency coil.

By the induction-heating apparatus configured as described above, because the driving frequency of the high-frequency coil matches with the driving frequency of the low-frequency coil, occurrence of noise due to a frequency difference between the heating coils may be effectively prevented. Also, because the control state of the inverter device corresponding to the high-frequency coil is different from the control state of the inverter device corresponding to the low-frequency coil, a heating power of each of the two heating coils may be adjusted to a desired level. According to an embodiment, the first control state may be a control state of turning on/off the switching device of the corresponding inverter device at a fixed duty ratio. According to an embodiment, the second control state may be a control state of turning on/off the switching device of the corresponding inverter device at a variable duty ratio.

Accordingly, because the switching device is turned on/off with a variable duty ratio in the second control state, a heating power of a high-frequency coil may be adjusted to a desired level. According to an embodiment, the second control state may be an asymmetric control state in which an on-duty ratio of a high side switching device of the inverter device is different from an on-duty ratio of a low side switching device of the inverter device. According to an embodiment, the on-duty ratio of the high side switching device of the inverter device may be in a range from 30% to 50%.

Therefore, a risk of failure of the switching device may be reduced or eliminated. In an embodiment, according to an output of the high-frequency coil which has not reached the target output in the second control state, the controller may convert a control of the inverter device corresponding to the high-frequency coil from the second control state to the third control state that is different from the second control state. Accordingly, even though a heating power of the high-frequency coil is not adjusted to a desired level only by changing a duty ratio in the second control state, a desired heating power may be obtained by converting a control of the inverter device corresponding to the high-frequency coil from the second control state into the third control state.

According to an embodiment, the third control state may be a state in which a driving frequency of the high-frequency coil is time-divisionally controlled into the first driving frequency that is a driving frequency of the low-frequency coil and the second driving frequency that is higher than the first driving frequency. According to an embodiment, a difference between the first driving frequency and the second driving frequency may be 15 kHz or greater.

According to the driving frequency of the high-frequency coil converted from the first driving frequency to the second driving frequency in the third control state, a frequency difference between the driving frequency of the high-frequency coil and the driving frequency of the low-frequency coil may be occur. By setting the difference between the first and second driving frequencies to be 15 kHz or greater, a heating power may be adjustable to a desired level, and noise caused by the frequency difference may not be recognized as noise. As a result of attempting to approximate the output of the high-frequency coil to the target output, a driving time of the second driving frequency may become very long. In this case, because a difference between the driving frequency of the low-frequency coil and the driving frequency of the high-frequency coil is very great, it may be difficult to recognize noise even though the two heating coils are driven at different driving frequencies.

In an embodiment, as described above, when a ratio of a driving time of the second driving frequency with respect to a driving time of the first driving frequency exceeds a threshold value in the third control state, the controller may convert a control state of the at least two inverter devices into a control state of driving the at least two heating coils at different driving frequencies. In an embodiment, the converted control state of the at least two inverter devices may be the first control state. In an embodiment, in the converted control state, the at least two inverter devices may be PFM-controlled at the same fixed duty ratio. Accordingly, while heating powers of both the low-frequency coil and the high-frequency coil are adjusted to desired levels, occurrence of noise due to such a frequency difference may be substantially reduced or effectively prevented. In an embodiment, according to a change of a driving frequency of a heating coil not being the low-frequency coil between the at least two heating coils to a driving frequency lower than a driving frequency of the low-frequency coil, the controller may change the driving frequency of the low-frequency coil to the driving frequency of the heating coil, convert a control state of the inverter device corresponding to the low-frequency coil into the second control state, and convert a control state of the inverter device corresponding to the heating coil into the first control state. Accordingly, even though a magnitude relationship of driving frequencies of the plurality of heating coils is reversed while heating powers by the plurality of heating coils are adjusted, an effect by the above-described control operation, that is, an effect that a heating power by each of the heating coils is adjusted to a desired level while eliminating noise occurring upon simultaneous heating of a plurality of objects to be heated, may be obtained.

In an embodiment, according to an on-duty ratio of the switching device corresponding to the high-frequency coil reaching 50% while the high-frequency coil is controlled in the second control state, the controller may change a heating coil corresponding to the high-frequency coil between the at least two heating coils to a low-frequency coil, and a heating coil corresponding to the low-frequency coil between the at least two heating coils to a high-frequency coil. In an embodiment, the controller may convert a control state of the inverter device corresponding to the heating coil changed to the high-frequency coil into the second control state, and convert a control state of the inverter device corresponding to the heating coil converted to the low-frequency coil into the first control state.

In an embodiment a driving frequency adjustable range of each of the at least two heating coils may be higher than a frequency at a peak of a resonant curve of an object that is heated by the heating coil. Accordingly, damage of the switching device by hard switching may be substantially reduced or effectively prevented.

Control operations by the controller 3 is not limited to the above-described embodiments. Hereinafter, other embodiments of control operations will be described.

In an embodiment, for example, the controller 3 may match a driving frequency of a power that is supplied to the first heating coil 1A with a driving frequency of a power that is supplied to the second heating coil 1B, and then, the controller 3 may continuously lower the driving frequency until an output of any one of the first heating coil 1A and the second heating coil 1B matches with a target output (hereinafter, this state is referred to as a transient state). Then, the controller 3 may match an output of another one between the first heating coil 1A and the second heating coil 1B with the target output (hereinafter, this state is referred to as a normal state).

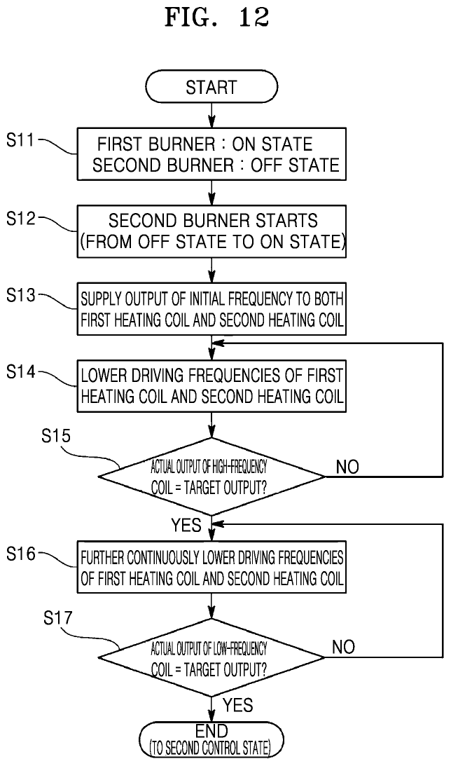

FIG. 12 is a flowchart showing an embodiment of an operation of controlling the induction-heating apparatus 100 by the controller 3. Hereinafter, a control state in a transient state will be described with reference to FIGS. 3, 4, and 12, and then, a control state in a normal state will be described with reference to FIGS. 5 and 6.

First, the control state in the transient state will be described. As shown in FIG. 12, a first burner corresponding to the first heating coil 1A may start.

A power of a preset driving frequency may be supplied to the first heating coil 1A, and an actual output (actual power) of the first heating coil 1A may be controlled to become a target output (target power) (S11). In this state, a case (S12) in which a second burner corresponding to the second heating coil 1B starts to supply a power to the second heating coil 1B is described. The power instructor 321 of the main controller 32 may indicate, to the second controller 3B, a target power (for example, wattage) that is a target output corresponding to a heating power of the second burner. Then, the control state instructor 322 may convert control states of the first controller 3A and the second controller 3B into a control state (hereinafter, referred to as the first control state) in a transient state based on the indication. Accordingly, the first controller 3A may control the first inverter device 2A to adjust a driving frequency of a power that is supplied to the first heating coil 1A to the first control state.

The second controller 3B may control the second inverter device 2B to adjust a driving frequency of a power that is supplied to the second heating coil 1B to the first control state.

The first control state may be, as shown in FIG. 3, a control of turning on/off the switching device SW of the inverter device 2 at a fixed duty ratio. For example, the first control state shown in FIG. 3 may be implemented by a PFM control in which an on-duty ratio is fixed to, for example, 50%.

The fixed duty ratio in the first control state is not limited to 50%. In the first control state, various fixed duty ratios in which a duty ratio of a switching device SW of a high side and a duty ratio of a switching device SW of a low side maintain an interpolation relationship may be applied. For example, a duty ratio of the switching device SW of the high side may be set to 60%, and a duty ratio of the switching device SW of the low side may be set to 40%. The first control state is not limited to the PFM control. For example, the first control state may be implemented by a PWM control. More specifically, the control state instructor 322 may instruct the inverter controller 312 corresponding to the first heating coil 1A to match a driving frequency of a power that is supplied to the first heating coil 1A with a preset initial frequency. Also, the control state instructor 322 may instruct the inverter controller 312 corresponding to the second heating coil 1B to match a driving frequency of a power that is supplied to the second heating coil 1B with the same initial frequency (S13). The initial frequency may be a frequency that is at least slightly higher than a driving frequency of a power that has been supplied to the first heating coil 1A before the second burner starts.

For example, the initial frequency may be a driving frequency of a power that is, upon conversion of the heating coil 1 from an off state to an on state, supplied to the corresponding heating coil 1, and the initial frequency may be a preset frequency.

For example, the preset frequency of the initial frequency may be a maximum driving frequency among driving frequencies of powers that may be supplied to the heating coils 1. Thereafter, the inverter controllers 312 of the first controller 3A and the second controller 3B may control the inverter devices 2 to lower the driving frequency of the first heating coil 1A and the driving frequency of the second heating coil 1B sequentially or in stages from the above-described initial frequency (S14). More specifically, the power calculators 311 of the first controller 3A and the second controller 3B may calculate actual outputs of the first heating coil 1A and the second heating coil 1B.

The first controller 3A and the second controller 3B may control the inverter devices 2 to continuously lower the driving frequency of the first heating coil 1A and the driving frequency of the second heating coil 1B until an actual output of any one of the first heating coil 1A and the second heating coil 1B reaches the target output. As such, by continuously lowering the driving frequencies, basically, an actual output of a heating coil having a lower target heating power between the first heating coil 1A and the second heating coil 1B may first match with the target output. However, there may be a case in which an actual output of a heating coil having a greater target heating power first matches with the target output, depending on a size or material of an object to be heated, such as a used pot, due to a small difference between target heating powers.

Hereinafter, one of which an actual output first matches with a target output, between the first heating coil 1A and the second heating coil 1B, is referred to as a high-frequency coil, and another one thereof is referred to as a low-frequency coil. The inverter controller 312 may compare an actual output of a high-frequency coil with a target output and control the inverter device 2 to lower a driving frequency of the first heating coil 1A and a driving frequency of the second heating coil 1B while synchronizing the driving frequency of the first heating coil 1A with the driving frequency of the second heating coil 1B until the actual output of the high-frequency coil matches with the target output (S14 and S15). In an embodiment, the driving frequency of the first heating coil 1A may not be synchronized with the driving frequency of the second heating coil 1B, and in a state in which the driving frequency of the first heating coil 1A is a little deviated from the driving frequency of the second heating coil 1B, the driving frequency of the first heating coil 1A and the driving frequency of the second heating coil 1B may be lowered.

However, the deviation between the driving frequency of the first heating coil 1A and the driving frequency of the second heating coil 1B may not be a frequency difference that causes noise. The deviation between the driving frequency of the first heating coil 1A and the driving frequency of the second heating coil 1B may be deviation that is at least less than the frequency difference that causes noise. Also, actually, it may be difficult to recognize which one of the first heating coil 1A and the second heating coil 1B is a high-frequency coil, and, in operation S15, an actual output of the first heating coil 1A may be compared with the target output while an actual output of the second heating coil 1B is compared with the target output. Also, a heating coil that first reaches the target output may be identified as a high-frequency coil.

As a result, the driving frequency of the high-frequency coil may match with the driving frequency of the low-frequency coil (hereinafter, the driving frequency is referred to as a transient frequency), and an actual output of the high-frequency coil may match with the target output (“YES” in S15). After the actual output of the high-frequency coil matches with the target output, the controller 3 may control the inverter device 2 to further continuously lower both the driving frequency of the first heating coil and the driving frequency of the second heating coil until an actual output of the low-frequency coil matches with the target output (S16 and S17). Driving frequency adjustable ranges of the first heating coil 1A and the second heating coil 1B may be dispersed as shown in the left side of FIG. 4. In this case, when a driving frequency of a high-frequency coil (for example, the first heating coil 1A) is adjusted to a driving frequency of a low-frequency coil (for example, the second heating coil 1B), the driving frequency of the high-frequency coil may become lower than a frequency (a frequency marked with an asterisk in FIG. 4) at a peak of a resonant curve.

Then, there may be a risk of damage of the switching device SW by hard switching.

By considering this, as shown in the graph at the right side of FIG. 4, a number of turns of each heating coil 1 or the resonant capacitor may be adjusted such that a driving frequency adjustable range of the first heating coil 1A is higher than a frequency at a peak of a resonance curve of an object that is heated by the second heating coil 1B, and a driving frequency adjustable range of the second heating coil 1B is higher than a frequency at a peak of a resonance curve of an object that is heated by the first heating coil 1A. By the above-described control state in the transient state, the driving frequency of the high-frequency coil may match with the driving frequency of the low-frequency coil (hereinafter, the driving frequency is referred to as a first driving frequency), and simultaneously, the actual output of the low-frequency coil may match with the target output (“YES” in S17).

A control state in a normal state will be described below.

By matching the driving frequency of the first heating coil 1A with the driving frequency of the second heating coil 1B through the above-described control in the transient state, the driving frequency of the high-frequency coil may be lowered to the first driving frequency from the transient frequency in the case of “YES” in S15.

As a result, because a heating power of the high-frequency coil becomes greater than a desired heating power, a control for lowering the heating power of the high-frequency coil may be desired. The controller 3 may maintain a control of the inverter device corresponding to the low-frequency coil in the first control state, while converting a control of the inverter device 2 corresponding to the high-frequency coil into a second control state that is different from the first control state. The second control state may be, as shown in FIG. 5, a control of turning on/off the switching device SW of the inverter device 2 with a variable duty ratio, and may be a (asymmetric) control of causing an on-duty ratio of a switching device SW of a high side to be different from an on-duty ratio of a switching device SW of a low side.

For example, in the second control state, the inverter controller 312 may compare an actual power supplied to a high-frequency coil with a target power corresponding to a target heating power, and lower an on-duty ratio of a switching device SW of the high side such that the actual power matches with the target power, that is, an output of the high-frequency coil matches with a target output. According to an embodiment, the on-duty ratio of the switching device SW of the high side may change in a range of 30% to 50%.

An on-duty ratio of a switching device SW of a low side may become a value resulting from subtracting the on-duty ratio of the switching device SW of the high side from 100%.

As a result of the on-duty ratio of the switching device SW of the high side being lower than, for example, 30%, the switching device SW may fail. However, a lower limit of an on duty ratio, which may cause failure of the switching device SW, is not limited to 30% and may vary depending on a configuration of the induction-heating apparatus 100. As such, by lowering an on-duty ratio of a switching device SW of a high side to match an actual power of a high-frequency coil with the target power, an output of the high-frequency coil may match with the target output. Thereby, heating powers of burners respectively corresponding to the first heating coil 1A and the second heating coil 1B may be adjusted to desired levels.

In an embodiment, even though the on-duty ratio of the switching device SW of the high side is lowered to the lower limit (30%) of the changeable range, an actual power of the high-frequency coil may not reach the target power, that is, an output of the high-frequency coil may not reach the target output. In this case, a heating power of a burner corresponding to the high-frequency coil may not be adjusted to a desired level. In this case, the control state instructor 322 may instruct the inverter controller 312 of the individual controller 31 corresponding to the high-frequency coil to convert a control of the inverter device 2 corresponding to the high-frequency coil into a third control state from the second control state.

The third control state may be a control state that is different from the second control state. The third control state may be, as shown in FIG. 6, a control of converting a driving frequency of a high-frequency coil into the above-described first driving frequency and a second driving frequency resulting from summing the first driving frequency and a preset frequency at preset periods. In the third control state, while the driving frequency of the high-frequency coil is converted from the first driving frequency to the second driving frequency, the driving frequency of the low-frequency coil may be maintained at the first driving frequency, and accordingly, a difference between the driving frequencies of both the coils may be made.

For example, a difference of about 10 kHz between the driving frequency of the high-frequency coil and the driving frequency of the low-frequency coil may cause noise. Accordingly, in an embodiment, a difference between a driving frequency of a high-frequency coil and a driving frequency of a low-frequency coil may be set to 15 kHz or greater. In the third control state according to an embodiment, the inverter controller 312 may change a ratio of a driving time of the first driving frequency and a driving time of the second driving frequency in a time period. For example, to match an actual power of a high-frequency coil with a target power, in other words, to match an output of the high-frequency coil with a target output, the inverter controller 312 may increase the driving time of the second driving frequency.

In an embodiment, as described above, by increasing the driving time of the second driving frequency to match the actual power of the high-frequency coil with the target power, the output of the high-frequency coil may match with the target output. Accordingly, heating powers of the burners respectively corresponding to the first heating coil 1A and the second heating coil 1B may be adjusted to desired levels. In the third control state, as a result of attempting to approximate an actual output of the high-frequency coil to the target output, the driving time of the second driving frequency may become very long. In this case, a difference between a driving frequency of the low-frequency coil and a driving frequency of the high-frequency coil may become great. Accordingly, although the first and second heating coils 1A and 1B are driven at different driving frequencies, a level of occurred noise may be a level that is difficult to be recognized as noise.

Accordingly, when a ratio of a driving time of the second driving frequency with respect to a driving time of the first driving frequency exceeds a threshold value, the control state instructor 322 may instruct the inverter controllers 312 of the first and second controllers 3A and 3B to convert control states by the first and second inverter devices 2A and 2B into a control state of driving the first heating coil 1A and the second heating coil 1B at different driving frequencies from the third control state. At this time, the converted control state may be the first control state. Accordingly, the switching device SW of the first inverter device 2A and the switching device SW of the second inverter device 2B may be PFM-controlled at the same fixed duty ratio.

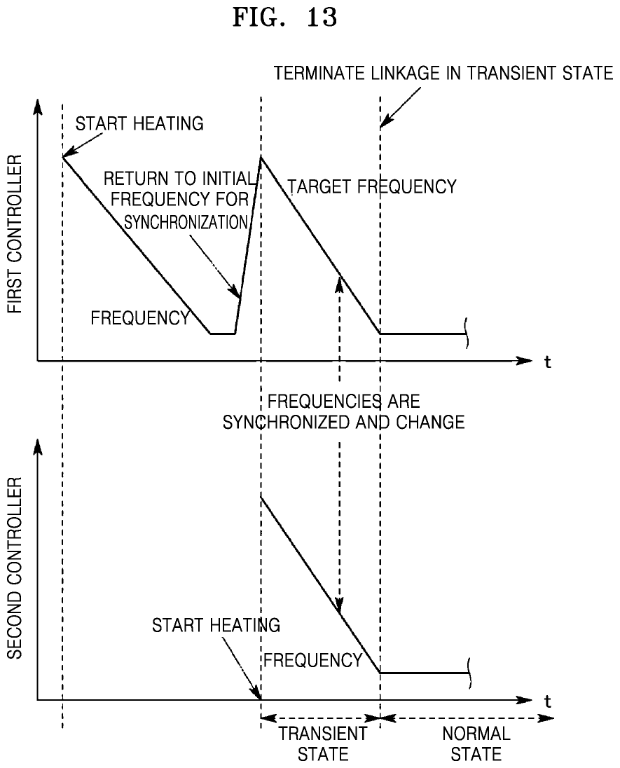

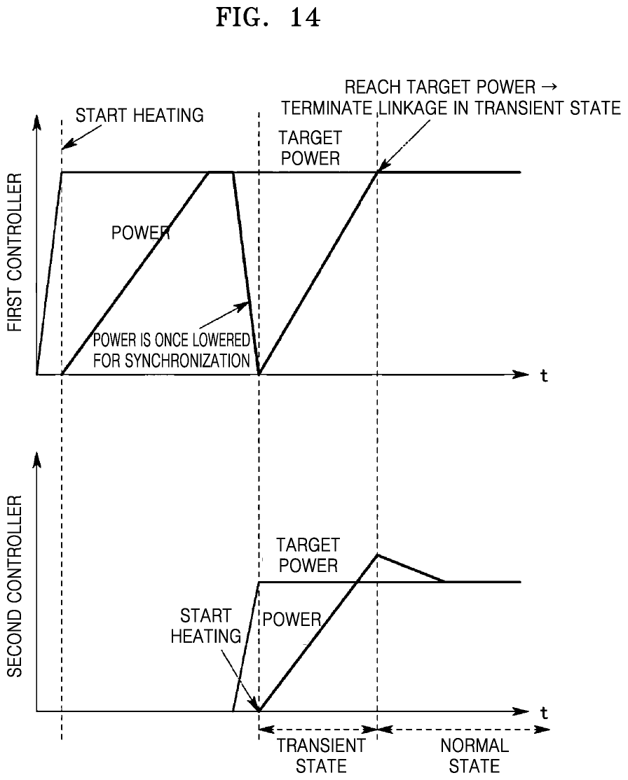

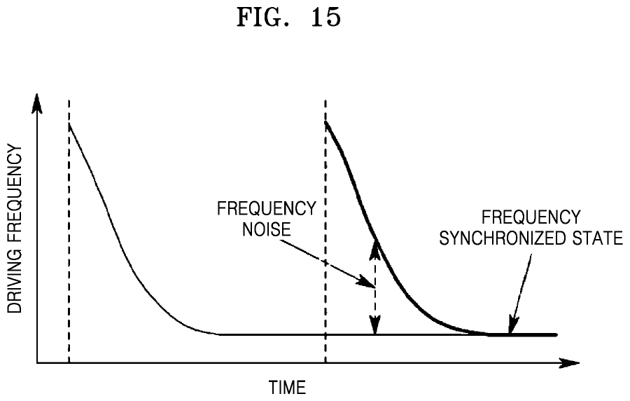

FIG. 13 is graphs showing sequential changes of driving frequencies in a control operation according to an embodiment of the disclosure, shown in FIG. 12. FIG. 14 is graphs showing sequential changes of outputs (powers) in a control method according to an embodiment of the disclosure, shown in FIG. 12. FIG. 15 is a graph showing occurrence of frequency noise in a process of matching driving frequencies of powers that are supplied to two heating coils.

Referring to FIG. 13, a power of a same initial frequency may be supplied to the first and second heating coils 1A and 1B at a start time of a transient state, and the initial frequency may be lowered while synchronizing driving frequencies of powers that are supplied to the first and second heating coils 1A and 1B with each other. Accordingly, no frequency difference may occur between the powers that are supplied to the first and second heating coils 1A and 1B, thereby effectively preventing occurrence of noise due to a frequency difference as shown in FIG. 15. Also, in a normal state, a control state of the inverter device 2 corresponding to a high-frequency coil may be converted into a second control state or a third control state that is different from the first control state of the inverter device 2 corresponding to a low-frequency coil. As a result, as shown in FIG. 8, a heating power of each of the first and second heating coils 1A and 1B may be adjusted to a desired level. A control operation is not limited to the above-described embodiments. For example, in an embodiment of a control operation, a control state of a high-frequency coil may be converted from the first control state to the second control state after an actual output of a low-frequency coil matches with a target output, however, a control state of the low-frequency coil may be converted from the first control state to the second control state after an actual output of the high-frequency coil matches with the target output.

In this case, the first control state may be a control state of setting, for example, a fixed duty ratio of a high side to be lower than 50% (for example, 30%), and the second control state may be a control state of gradually raising a variable duty ratio of a high side from the fixed duty ratio of the first control state toward 50%. Also, according to an actual output of the low-frequency coil which has not reached the target output in the second control state, the control state of the low-frequency coil may be converted into the third control state. At this time, the third control state according to an embodiment may be a control state of converting a driving frequency of a low-frequency coil to the first driving frequency being a driving frequency of a high-frequency coil and a second driving frequency resulting from subtracting a preset frequency from the first driving frequency at preset periods.

The disclosure may provide an embodiment of the induction-heating apparatus capable of reducing or preventing occurrence of noise depending on a frequency difference while matching driving frequencies of two heating coils with each other. The induction-heating apparatus according to an embodiment of the disclosure may include: at least two heating coils configured to heat an object to be heated by induction heating; at least two inverter devices connected to the at least two heating coils and configured to supply powers to the corresponding heating coils; and a controller configured to control the at least two inverter devices.

As a result of starting, while a power of a preset driving frequency is supplied to one heating coil between the at least two heating coils, to supply a power to another heating coil between the at least two heating coils, the controller may control the at least two inverter devices to supply powers of an initial frequency being higher than the preset driving frequency to both the at least two heating coils and then lower frequencies of the powers supplied to both the at least two heating coils until an output of the one heating coil matches with a target output.

By the induction-heating apparatus, at a start time of a transient state at which a power starts being supplied to one heating coil while a power is supplied to another heating coil, powers of a preset initial frequency may be supplied to the two heating coils. Then, by lowering driving frequencies of the powers that are supplied to the two heating coils from the initial frequency while synchronizing the driving frequencies of the powers that are supplied to the two heating coils with each other, occurrence of noise in the transient state, caused by a difference between the driving frequencies, may be effectively prevented.

According to an embodiment, the controller may control the inverter device to lower frequencies of the powers that are supplied to both the at least two heating coils until the output of the one heating coil matches with the target output thereof, and then, further continuously lower frequencies of the powers that are supplied to the at least two heating coils until the output of the other heating coil matches with the target output thereof. As a control state after the output of the one heating coil matches with the target output thereof, a method of matching the output of the other heating coil with the target output by changing, for example, a duty ratio while maintaining a driving frequency at that time may be considered.

It may be difficult to predict change of the duty ratio to match the output of the other heating coil with the target output, depending on a cooking tool such as a pot to be heated. Also, it may be difficult to be certain that the output of the other heating coil will reach the target output by increasing the duty ratio while maintaining the driving frequency. As a result, in a case in which the output of the other heating coil does not reach the target output, the subsequent control may become complicated. In an embodiment of the disclosure, a frequency when the output of the other heating coil matches with the target output may be obtained after the output of the one heating coil matches with the target output, and in that state, again matching an output of the one heating coil with the target output may be a control in a direction of reducing the output, which avoids complexity of the control. As a result, outputs of the two heating coils may be more reliably controlled to be the target output. According to an embodiment, the controller may continuously lower frequencies of powers that are supplied to the at least two heating coils until the output of the other heating coil matches with the target output, and then, the controller may control the inverter device corresponding to the one heating coil in a control state that is different from that of the inverter device corresponding to the other heating coil. Accordingly, because a control state using a fixed on-duty ratio is applied in the transient state until the output of the other heating coil matches with the target output and in the subsequent normal state, only a control state of a power supplied to the other heating coil is converted into a control using an asymmetric on-duty ratio, a control operation (control program) may be simplified.

According to an embodiment, the controller may control the inverter device to lower the frequencies of the powers that are supplied to the at least two heating coils from the initial frequency, while synchronizing the frequencies of the powers that are supplied to the at least two heating coils with each other. Accordingly, noise in the transient state may be more effectively prevented.

According to an embodiment, the initial frequency may be a preset frequency of a power that is supplied to a heating coil converted from an off state to an on state between the at least two heating coils. Accordingly, the above-described effects may be implemented without complicating a control program.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An induction-heating apparatus comprising:
at least two heating coils configured to heat an object to be heated by induction heating;
at least two inverter devices connected to the at least two heating coils, respectively, and configured to supply power to the at least two heating coils, respectively; and
a controller configured to control the at least two inverter devices,
wherein the controller is configured to
compare driving frequencies, which are frequencies of the power supplied to the at least two heating coils, with each other,
change a driving frequency of a high-frequency coil to a driving frequency of a low-frequency coil, when a heating coil having a higher driving frequency among the at least two heating coils is the high-frequency coil and a heating coil having a lower driving frequency among the at least two heating coils is the low-frequency coil,
control an inverter device corresponding to the low-frequency coil among the at least two inverter devices in a first control state, and
control an inverter device corresponding to the high-frequency coil among the at least two inverter devices in a second control state, which is different from the first control state.

2. The induction-heating apparatus of claim 1, wherein
the first control state is a control state of turning on/off a switching device of an inverter device based on a fixed duty ratio, and
the second control state is a control state of turning on/off a switching device of an inverter device based on a variable duty ratio.

3. The induction-heating apparatus of claim 1, wherein
the second control state is an asymmetric control state in which an on-duty ratio of a high-side switching device of an inverter device is different from an on-duty ratio of a low-side switching device of the inverter device.

4. The induction-heating apparatus of claim 1, wherein the controller is configured to convert a control state of the inverter device corresponding to the high-frequency coil from the second control state to a third control state, which is different from the second control state, when an output of the high-frequency coil does not reach a target output in the second control state, and
the third control state is a state in which a driving frequency of the high-frequency coil is time-divisionally controlled into a first driving frequency, which is a driving frequency of the low-frequency coil, and a second driving frequency, which is higher than the first driving frequency.

5. The induction-heating apparatus of claim 4, wherein a difference between the first driving frequency and the second driving frequency is 15 kHz or greater.

6. The induction-heating apparatus of claim 4, wherein, when a ratio of a driving time of the second driving frequency with respect to a driving time of the first driving frequency exceeds a threshold value in the third control state,
the controller is configured to convert a control state of the at least two inverter devices into a control state of driving the at least two heating coils at different driving frequencies.

7. The induction-heating apparatus of claim 1, wherein, when a driving frequency of a heating coil other than the low-frequency coil among the at least two heating coils is lower than a driving frequency of the low-frequency coil,
the controller is configured to
change the driving frequency of the low-frequency coil to the driving frequency of the heating coil,
convert a control state of the inverter device corresponding to the low-frequency coil into the second control state, and
convert a control state of the inverter device corresponding to the heating coil into the first control state.

8. The induction-heating apparatus of claim 1, wherein, when an on-duty ratio of a switching device corresponding to the high-frequency coil reaching 50% while the high-frequency coil is controlled in the second control state,
the controller is configured to change the heating coil corresponding to the high-frequency coil among the at least two heating coils to a low-frequency coil, and the heating coil corresponding to the low-frequency coil among the at least two heating coils to a high-frequency coil.

9. The induction-heating apparatus of claim 8, wherein the controller is configured to convert a control state of the inverter device corresponding to the heating coil changed to the high-frequency coil into the second control state, and convert a control state of the inverter device corresponding to the heating coil converted to the low-frequency coil into the first control state.

10. The induction-heating apparatus of claim 1, wherein a driving frequency adjustable range of each of the at least two heating coils is higher than a frequency at a peak of a resonance curve of the object to be heated by the heating coil.

11. An induction-heating apparatus comprising:
at least two heating coils configured to heat an object to be heated by induction heating;
at least two inverter devices connected to the at least two heating coils, respectively, and configured to supply power to the at least two heating coils, respectively; and
a controller configured to control the at least two inverter devices,
wherein, when, while a power of a certain driving frequency is supplied to one heating coil among the at least two heating coils, a power starts to be supplied to another heating coil among the at least two heating coils, the controller is configured to control the at least two inverter devices to supply power of an initial frequency, which is higher than the certain driving frequency, to both the at least two heating coils and lower frequencies of the power supplied to both the at least two heating coils until an output of the one heating coil matches with a target output thereof.

12. The induction-heating apparatus of claim 11, wherein the controller is configured to control the at least two inverter devices to further continuously lower the frequencies of the power supplied to the at least two heating coils until an output of the another heating coil matches with a target output thereof, after lowering the frequencies of the power supplied to both the at least two heating coils until the output of the one heating coil matches with the target output thereof.

13. The induction-heating apparatus of claim 12, wherein the controller is configured to control an inverter device corresponding to the one heating coil in a control state, which is different from a control state of the inverter device corresponding to the another heating coil, after continuously lowering the frequencies of the power supplied to the at least two heating coils until the output of the another heating coil matches with the target output thereof.

14. The induction-heating apparatus of claim 11, wherein the controller is configured to control the inverter devices to lower, while lowering the frequencies of the power supplied to the at least two heating coils, the frequencies of the power from the initial frequency while synchronizing the frequencies of the power supplied to the at least two heating coils with each other.

15. The induction-heating apparatus of claim 11, wherein the initial frequency is a preset frequency of a power, which is supplied to a heating coil converted from an off state to an on state among the at least two heating coils.
